(19) United States
(12) Patent Application Publication
(10) Pub. No.: US 2006/0263169 A1
(43) Pub. Date: Nov. 23, 2006

(54) Screw plug for repairing pressure vessels

(76) Inventors: Ed Archuleta, Salt Lake City, UT (US); Billy E. Wells, West Valley City, UT (US)

Correspondence Address: THORPE NORTH & WESTERN, LLP., 8180 SOUTH 700 EAST, SUITE 200, SANDY, UT, 84070, US

(21) Appl. No.: 11/409,486

(22) Filed: Apr. 20, 2006

Related U.S. Application Data
(60) Provisional application No. 60/673,028, filed on Apr. 20, 2005.
(60) Provisional application No. 60/719,927, filed on Sep. 22, 2005.

(51) Int. Cl. F16B 33/00

(52) U.S. Cl. 411/378

(57) ABSTRACT

A screw plug having a multiple-thread configuration formed along a screw shaft, wherein the multiple-thread configuration is configured to reduce the number of revolutions required to set the screw plug into a pressure vessel for repair of a puncture therein. The screw plug may be combined with a sealing agent to improve the airtight seal created by the insertion and setting of the screw plug, which sealing agent is configured to bond with the pressure vessel, thus providing a more long-term repair. A screw plug having a thread configuration with a flat upper pressure surface is also disclosed.

### RELATED APPLICATIONS

This application claims the benefit of U.S. Provisional Ser. No. 60/673,028, filed Apr. 20, 2005, and entitled, “Screw Plug for Tire Punctures;” and U.S. Provisional Ser. No. 60/719,927, filed Sep. 22, 2005, and entitled, “Method and System for Repairing a Puncture in a Pressurized Vessel,” each of which are incorporated by reference in their entirety herein.

### FIELD OF THE INVENTION

This invention relates generally to the repair of various pressurized vessels, such as vehicle tires. More particularly, the invention relates to improved methods for pressurized vessel repair, as well as plugs for repairing and sealing punctures in such pressurized vessels, such as a multiple entry screw plug, and systems for containing and using such plugs.

### BACKGROUND OF THE INVENTION AND RELATED ART

Pressurized vessels are in common use today. Hoses, sporting balls and vehicle tires are common articles that utilize fluid or air pressure in order to function properly. Generally, each pressurized article or vessel depends on a level of pressure to exhibit certain characteristics. Failure of a pressurized vessel to retain pressure can cause significant problems, especially if a similar replacement vessel is not immediately available.

In the case of the vehicle tire, pressure loss, such as due to a puncture, can cause many potential problems that can range from a mere inconvenience to life threatening. Moreover, the loss of pressure in a vehicle tire can cause significant property damage to the vehicle if operation of the vehicle is continued without repairing or changing the tire. Although replacing a vehicle tire having a puncture with a new one is perhaps the most proper and safe course of action, sudden flat tires can occur in obscure places leaving the operator no choice, but to temporarily replace the punctured and flat vehicle tire with the spare tire which can be a time consuming and labor intensive process, or to use a type of roadside repair method.

Roadside remedies used to repair a punctured and deflated tire and to get the vehicle back on the road include such items as patches, plugs and pressurized cans of sealant. Each of these has associated problems. Patches can be difficult because tires frequently have tread and a seal is difficult to obtain without completely removing the tire from the rim and placing the patch on the inside surface, thus defeating the purpose of a roadside repair. Cans of sealant can cause the tire to become off-balance, thus requiring follow-up repair or replacement of the tire. In addition, if a can of sealant is used, the rim and tire must be cleaned and free of debris in order to achieve a proper seal.

Plugs can provide a more long-term repair if done correctly. However, many of these are disadvantageous because they require the removal of the tire from the rim for placement on the inside of the tire.

There are several different types of tire plugs that do not require removal of the tire. “Bowtie plugs” depend on a probe to further open the hole and a needle tool to insert the bowtie plug. The bowtie plug requires a sealant to hold the plug in place. “Mushroom plugs” require a process of loading the mushroom plug in a special gun, which pushes the plug through the tire and then pulls the plug back a distance until the head of the mushroom plug is seated against the inside of the tire. Although functional, each of these plugs require specialized tools and instructions.

Another type of plug that does not require removal of the tire from the rim is a screw plug. Screw plugs, often referred to as tire screws, are designed to be driven or inserted into a puncture hole to seal the puncture from the outside of the tire. Tire screw plugs are typically conical in shape, have a set of spiral threads disposed about a central shaft, and a head. Some require boring a slot for the screw head to sit flush on the tire. While they might not require special tools, there are various problems associated with these prior art tire screws. First, because of their single thread design, many prior art tire screws require many turns in order properly seat the head against and flush with the tire. Second, many existing tire screws comprise dull thread design and/or short thread height incapable of cutting into the wall of the tire. This significantly limits the ability of the tire screw to remain seated within the tire and to properly repair the punctured tire. Third, many existing tire screws offer only a temporary solution, thus requiring the tire to be more permanently repaired or replaced at a later time.

### SUMMARY OF THE INVENTION

In light of the problems and deficiencies inherent in the prior art, the present invention seeks to overcome these by providing a screw plug for a pressure vessel, wherein the screw plug is configured to provide a more permanent and durable seal of a puncture in the pressure vessel.

In accordance with the invention as embodied and broadly described herein, the present invention features a screw plug for repair of a puncture in a pressure vessel, wherein the screw plug comprises: (a) a screw shaft having a cylindrical configuration and a longitudinal central axis extending therethrough; (b) a first thread configuration disposed about the screw shaft; and (c) a second thread configuration disposed about the screw shaft and extending parallel to the first thread configuration, the first and second thread configurations initiating at different locations to provide a multiple-thread configuration.

The present invention also features a screw plug for repairing a puncture in a pressure vessel, wherein the screw plug comprises: (a) a screw shaft; (b) a multiple-thread configuration formed about the screw shaft to reduce the number of revolutions required to insert and set the screw plug; (c) a head portion extending from the screw shaft, the head portion having a driving slot formed therein; and (d) a tapered screw tip, devoid of threading, configured to aid in alignment of the screw plug with respect to the puncture.

The present invention further features a method for repairing a pressure vessel, wherein the method comprises: (a) locating a puncture in the pressure vessel; (b) obtaining a screw plug comprising a multiple-thread configuration configured to reduce the number of revolutions required to seat the screw plug within the pressure vessel, a screw tip, a head portion having a tapered shaft and a rim extending outward from the tapered shaft; (c) aligning the screw tip with the puncture; and (d) rotating the screw plug to cause the multiple-thread configuration to impale a wall of the pressure vessel, and to set the screw plug to create an airtight seal.

The present invention still further features a screw plug for repairing a pressure vessel, wherein the screw plug comprises: (a) a screw shaft having a first end and a second end; (b) a truncated conical head portion, devoid of threads, and located about the first end of the screw shaft, the head portion further comprising a rim extending outward therefrom; and (c) a thread configuration disposed along the screw shaft, the thread configuration comprising a flat, upper surface substantially orthogonal to a longitudinal axis of the screw plug, and a lower surface extending from the upper surface at an angle between 10 and 60 degrees, as measured from the upper surface.

In one exemplary embodiment, the screw plug comprises a multiple-thread configuration. As such, the screw plug may comprise two or more threads cut beside each other and disposed along the shaft of the screw plug.

The invention is useful in a system for repairing a puncture within a pressurized vessel which contains a screw plug having a multiple entry thread configuration and a sealing agent configured to lubricate the screw during entry and then bond the tire and screw together.

### BRIEF DESCRIPTION OF THE DRAWINGS

The present invention will become more fully apparent from the following description and appended claims, taken in conjunction with the accompanying drawings. Understanding that these drawings merely depict exemplary embodiments of the present invention they are, therefore, not to be considered limiting of its scope. It will be readily appreciated that the components of the present invention, as generally described and illustrated in the figures herein, could be arranged and designed in a wide variety of different configurations. Nonetheless, the invention will be described and explained with additional specificity and detail through the use of the accompanying drawings in which:

FIG. 1 illustrates a perspective view of a screw plug in accordance with one exemplary embodiment of the present invention;

FIG. 2 illustrates a side view of the screw plug of FIG. 1;

FIG. 3 illustrates a cross-sectional top view of the screw plug of FIG. 1 taken along lines A-A;

FIG. 4 illustrates a cross-sectional side view of the screw plug of FIGS. 1 and 2, taken along the longitudinal axis;

FIG. 5 illustrates a partial, cut-away view of the screw plug of FIG. 1 as partially inserted into a puncture of a tire;

FIG. 6 illustrates a screw plug in accordance with another exemplary embodiment of the present invention;

FIG. 7 illustrates a side view of a screw plug in accordance with still another exemplary embodiment of the present invention;

FIG. 8 illustrates a side view of a screw plug in accordance with still another exemplary embodiment of the present invention; and

FIG. 9 illustrates a repair system utilizing a screw plug of the present invention.

### DETAILED DESCRIPTION OF EXEMPLARY EMBODIMENTS

The following detailed description of exemplary embodiments of the invention makes reference to the accompanying drawings, which form a part hereof and in which are shown, by way of illustration, exemplary embodiments in which the invention may be practiced. While these exemplary embodiments are described in sufficient detail to enable those skilled in the art to practice the invention, it should be understood that other embodiments may be realized and that various changes to the invention may be made without departing from the spirit and scope of the present invention. Thus, the following more detailed description of the embodiments of the present invention is not intended to limit the scope of the invention, as claimed, but is presented for purposes of illustration only and not limitation to describe the features and characteristics of the present invention, to set forth the best mode of operation of the invention, and to sufficiently enable one skilled in the art to practice the invention. Accordingly, the scope of the present invention is to be defined solely by the appended claims.

The following detailed description and exemplary embodiments of the invention will be best understood by reference to the accompanying drawings, wherein the elements and features of the invention are designated by numerals throughout.

The present invention describes a method and system for repairing one or more punctures in a pressurized vessel or air-containing article, including, but not limited to, those made of rubber, flexible plastic materials, and the like. One example of a pressurized vessel is a tubeless vehicle tire. While those skilled in the art will recognize that the present invention is useful more broadly for repair of pressurized vessels in general, which pressurized vessels may be of various types, it is for convenience to the reader that the present invention shall be described below with reference being made primarily to a pressurized vessel in the form of a tubeless vehicle tire. However, the description of a vehicle tire should not be construed as limiting in any way. Indeed, the present invention may be configured for use with other pressurized vessels that may include, for example, inner tubes, pontoons, rafts, sports balls (e.g., footballs, basketballs, volleyballs, etc.) and other flexible or elastic pressure vessels. It is noted herein that the type of pressure vessel best suited for repair by the present invention screw plug preferably comprises one or more elastic properties that allow the screw plug to cut, set and bond with the material making up all or a portion of the pressurized vessel.

Essentially, the screw plug is intended for insertion into a puncture of a tire (or other pressure vessel as noted above). The screw plug may be used by identifying or locating a puncture in the tire, and then gradually inserting the screw plug into the puncture until properly set or seated so that the screw plug extends through the wall of the tire and seals the puncture. In most cases, a properly seated position will involve turning the screw plug so that a head portion is caused to be forced against and flush with an outer surface of the tire. If there are several punctures in the tire, a corresponding number of plugs can be used.

The present invention provides several significant advantages over prior related repair devices, objects, systems, and the corresponding methods employing these. For example, the various embodiments of the present invention screw plug with their corresponding repair method provide easy to use designs that are more efficient and effective than prior related screw plugs. Each of the discussed screw plugs also allow the user to repair punctures in a vehicle tire without removing the tire from the rim, thus resulting in a repair that is achieved with much less effort. In addition, the screw plug may be used on-site without having to relocate the tire to another location to perform the repair. For example, a screw plug configured in accordance with the present invention may be used to repair a puncture in a flat car tire while the tire is still on the vehicle and the vehicle at the location where the flat occurred, thus facilitating convenience, limiting delay, and preventing safety hazards that may arise with removing the tire. The screw plugs are also configured to cut into the tire and to draw adjacent portions of the tire toward the screw plug, thus achieving a more secure and lasting seal. As an additional advantage, unlike other screw plugs, the present invention screw plugs require no specialized tools for use. Rather, the present invention screw plugs may be configured to be operable with common tools, such as a screwdriver, allen wrench, star wrench, or others.

In the embodiment disclosing a screw plug having multiple threads or a multiple entry thread design, as will be discussed in greater detail below, a further advantage is that fewer turns or revolutions of the screw plug are required to fully insert and properly seat the screw plug into the tire to seal the puncture.

Each of the above-recited advantages, and any others discussed herein, will be apparent in light of the detailed description set forth below, with reference to the accompanying drawings. These advantages are not meant to be limiting in any way. Indeed, one skilled in the art will appreciate that other advantages may be realized, other than those specifically recited herein, upon practicing the present invention.

Speaking of the present invention screw plugs generally, the material composition of the screw plugs may be any material or composition of materials capable of withstanding the harsh conditions under which a tubeless vehicle tire operates (e.g., exposure to prolonged periods of heat and cold, fluctuations in pressure and applied forces, changes in temperature, and other similar conditions). Any such material known in the art is contemplated for use, including various rubber, plastic, and vinyl materials. In one aspect of the invention, the screw plug may be formed of a hard rubber, a relatively rigid elastomer, or a tough plastic. In one aspect of the invention, the screw plug material comprises ST1-11 sold by DuPont. The screw plug can also advantageously comprise one or more reinforcing materials, such as an interior fibrous material or metal.

The present invention screw plug can be manufactured using any known process in the art. For example, the screw plug can be integrally formed as a single unit by a injection molding or other similar process. Those skilled in the art will recognize the various types of manufacturing processes that may be used to form a screw plug in accordance with the teachings herein.

The screw plugs can also be used in combination with an additive or sealing agent for helping seal the screw plug in the tire. Examples of such additives or sealing agents include, but are not limited to, liquid sealants, such as a “liquid” rubber compound or tire cement that softens the rubber surrounding the puncture, and that then bonds with the tire and the screw plug to provide the desired seal. Because the screw plug thread configuration is designed to form its own path as the screw plug advances into the tire and expands the rubber of the tire, the rubber of the tire, which is effectively softened by the additive, is easily penetrated by the high strength teeth. As such, this causes the softened rubber of the tire to more easily enter the roots of the thread configuration. After time, the rubber of the tire re-vulcanizes in these root locations, providing increased resistance to outward movement of the screw plug from the tire.

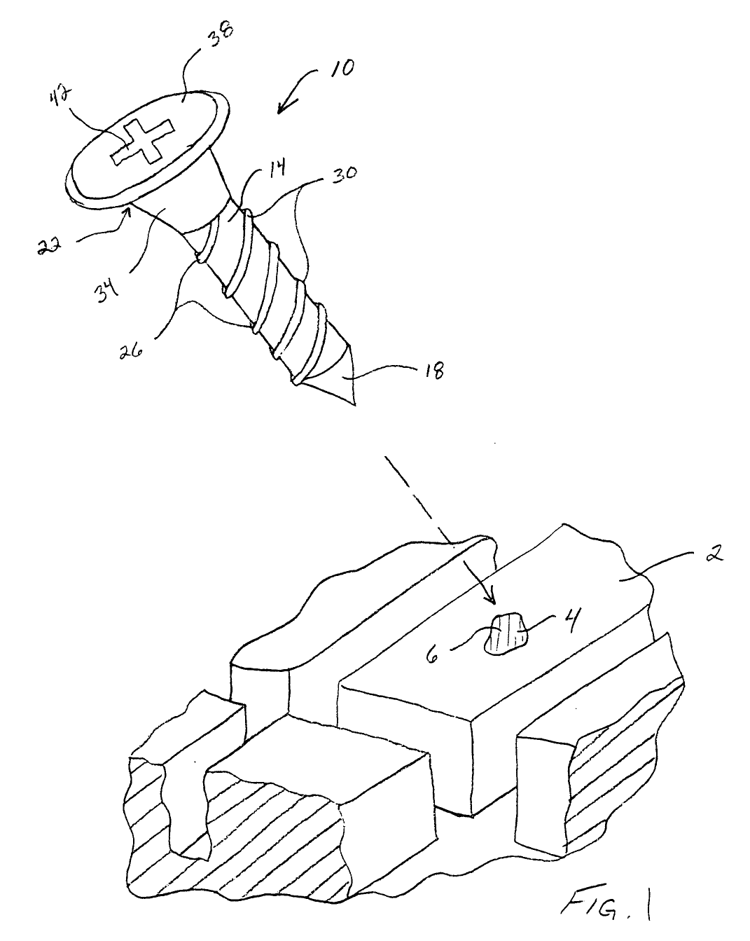

With reference to FIGS. 1, 2, and 4, illustrated is a screw plug in accordance with one exemplary embodiment of the present invention, wherein the screw plug is particularly configured for use in repairing a vehicle tire. The screw plug 10 is configured for insertion into a puncture 4 formed in a tire 2 for the purpose of creating an airtight seal to seal the puncture, and to prevent air from flowing or leaking out of the puncture 4 and the tire 2. In general, the screw plug 10 comprises three primary components, namely a screw shaft 14 having at least one thread configuration formed thereon, a screw tip 18, and a head portion 22, each of which are described in greater detail below.

The screw shaft 14 may comprise a cylindrical or tapering configuration, although the screw plug 10, as shown, comprises a cylindrical configuration. The screw shaft 14 comprises a diameter 16 that is also representative of the minor diameter of the screw plug 10. As will be obvious to one skilled in the art, the screw shaft 14, and also the entire screw plug 10, may comprise any desired size. Thus, depending upon the size of the puncture in a tire, the appropriate screw plug may be used. In any event, it is intended that the screw shaft 14 comprise a larger diameter than the puncture it is used to repair and seal. In addition, it is intended that the axial length of the screw plug be such that it passes through the tire and underlying tire layers to enter the inner air space within the tire.

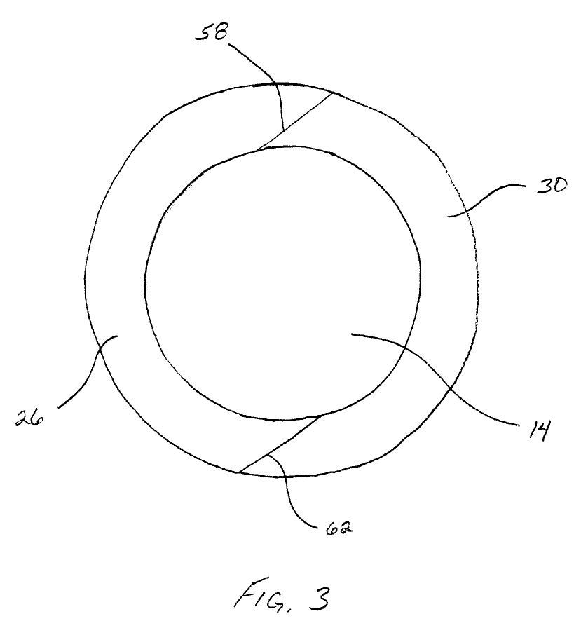

As shown, the present invention screw plug 10 comprises a multiple-thread design or multiple-thread configuration, meaning that two or more individual thread configurations are disposed about the screw shaft 14. In the exemplary embodiment shown, the screw plug 10 comprises two thread configurations formed about the screw shaft 14, shown as first and second thread configurations 26 and 30. First and second thread configurations are offset from one another by 180° when viewing the screw plug, and particularly the screw shaft 14 down its longitudinal axis (see FIG. 3). The first and second thread configurations 26 and 30 form two helical patterns about the screw shaft 14, running between the head portion 22 and the screw tip 18 in a parallel manner with one another.

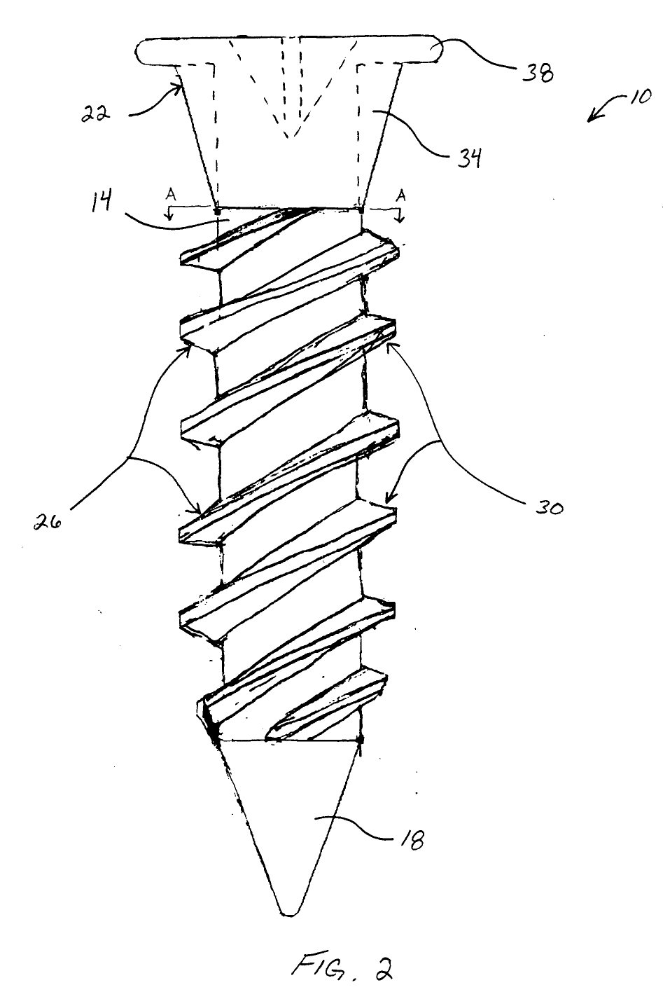

In effect, a multiple-thread configuration refers to more than one thread configuration on a plane perpendicular to a spin axis of the screw plug. Indeed, two or three or more thread configurations may be employed, each offset from the other a given distance. The function of the multiple-thread design is to provide a multiple entry design to reduce the number of revolutions a screw plug must be rotated to be set. In its set position, the screw plug will be seated in a position so as to provide and airtight seal, thus sealing the puncture 4 of the tire 2. In one aspect, the screw plug 10 will be seated in a position so as to cause a rim extending out from the head portion 22 to seat against a surface of the tire. For instance, with specific reference to the screw plug of FIGS. 1 and 2, once the tapered screw tip 18 has penetrated the tire surface and the first and second thread configurations 26 and 30 become engaged with and start to penetrate the wall 6 of the tire 2, only three revolutions of the screw plug 10 are required to fully seat the rim 38 against the surface of the tire 2. A multiple-thread configuration further functions to reduce the likelihood that the screw plug 10 will dislodge or work itself free from the tire 2. Indeed, by employing multiple entry and offset threads, the likelihood that screw plug 10 will back out of the tire 2 is reduced. This is because more than one thread configuration provides additional gripping power, wherein the various thread configurations complement one another as they are caused to penetrate and impale the wall 6 of the tire 2.

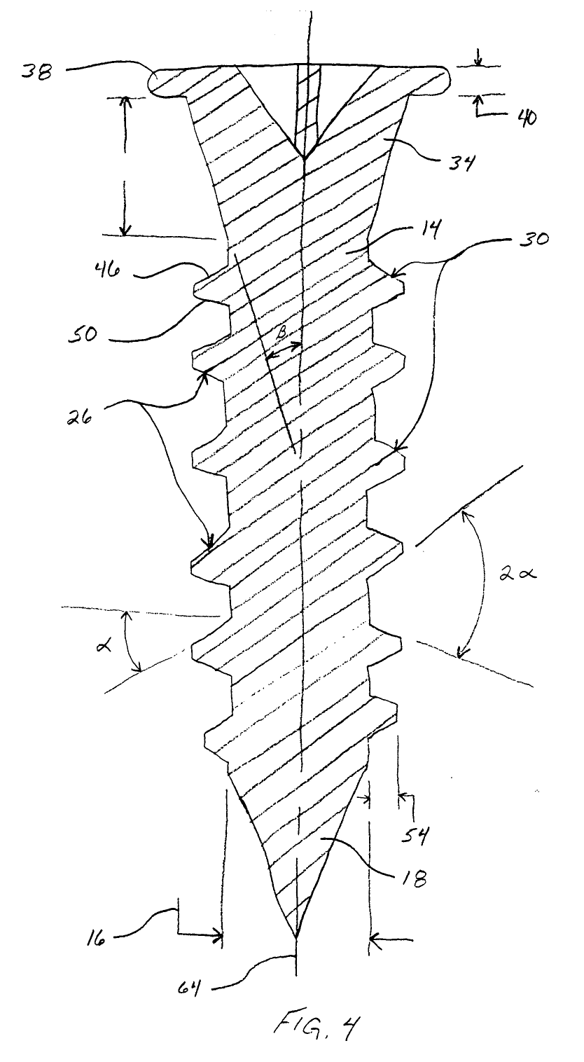

In the exemplary embodiment shown, the screw plug 10, and particularly the first and second thread configurations 26 and 30, comprise very sharp, double deep cutting edges, shown as edges 46 and 50, along the depth 54 of the threads (see FIG. 4). This effectively functions to increase the pulling power of the screw plug and its ability to rapidly impale or cut into the tire 2. Pulling power is referred to as the inherent ability of the screw plug to draw itself into the tire upon being rotated. In other words, an increase in pulling power results in a decrease of the required force that must be exerted on the screw plug along its longitudinal axis (e.g., manual downward force from a user through a driving tool) in order to properly set the screw plug. The thread angle 2α is intended to be between 40 and 70 degrees. Thus, the half angle α of the thread α is intended to be between 20 and 35 degrees.

With reference to FIG. 3, illustrated is a cross-sectional top view of the screw plug 10 of FIGS. 1 and 2. As shown, first and second thread configurations 26 and 30 comprise different starting positions 58 and 62, respectively. Because there are two thread configurations, the initial starting positions for first and second thread configurations 26 and 30 are opposite one another, each being offset from the other by substantially 180°. Although not shown, first and second thread configurations 26 and 30 also terminate at locations opposite one another, each being offset from the other by substantially 180°. Of course, as one skilled in the art will recognize, other thread patterns are contemplated, as well as the use of more than two thread configurations. Referring again to FIGS. 1, 2, and 4, the head portion 22 of the screw plug 10 comprises a truncated conical configuration extending from an upper end of the screw shaft 14 in a tapered manner. The head portion 22 is designed to aid in setting the screw plug 10, and in sealing the puncture 4 of the tire 2. As shown, the head portion 22 comprises a tapered shaft 34 having a head angle β between 1 and 30 degrees, and preferably between 2 and 20 degrees. The tapered shaft 34 is designed to be physically embedded into the tire as the screw plug 10 is inserted and driven into the puncture 4, and as the screw plug 10 is properly set. As the tapered shaft 34 comes in contact with the tire 2 and begins to be driven into the tire 2, the head portion 22, and particularly the tapered shaft 34, forces the wall 6 of the tire 2 to expand outward, this being due to the upwardly tapering configuration of the head portion 22, thus increasing the pressure between the tire 2 and the screw plug 10. The increased pressure effectively improves the seal of the puncture 4 by the screw plug 10. The tapered shaft 34 may or may not comprise threads. Stated differently, the tapered shaft results in an increasing compressive force between the tire and the plug as the plug is inserted into the tire.

The head portion 22 of the screw plug 10 further comprises a driving slot 42, which can be configured to receive a standard driver such as a standard Phillips or flathead screwdriver, an Allen wrench, a star wrench, or any other commonly known type of tool suitable for rotating and therefore driving the screw plug. As such, no special tools are required to set the screw plug as with many prior related plugs.

The head portion 22 may further comprise a rim 38 located atop the tapered shaft 34, which rim 38 extends outward from the tapered shaft 34 in all directions as shown, and comprises a height 40. The rim 38 functions to seat against a surface of the tire 2 when the screw plug 10 is properly inserted into the puncture 4 and completely set. As such, it can be said that the rim 38 functions, in part, to identify or signal a proper insertion. The rim 38 is also configured to retain a sealing agent, if used. As the sealing agent works its way up the screw shaft 14 and head portion 22 as the screw plug 10 is being driven into the tire 2, the rim 38 functions as a barrier to contain or retain the sealing agent. Thus, the rim 38 functions to hold the sealing agent in place to allow the sealing agent to bond to the tire 2, thus properly sealing the puncture 4.

The screw plug 10 further comprises a screw tip 18 configured to facilitate in the alignment and driving of the screw plug. The screw tip 18 may be tapered and will typically not comprise any threads. The screw tip 18 is designed to initially impale the tire 2, separating its wall 6, to allow the various thread configurations 26 and 30 engage or catch and also impale the wall 6 of the tire 2. The screw tip 18 is configured with a suitable design such that, despite the puncture diameter, minimal effort is required to impale the tire 2 and push the screw plug 10 in far enough for the thread configurations 26 and 30 to catch to effectuate entry. As shown, the screw tip 18 comprises a conical shape having a tapering surface between 20 and 45 degrees, as measured from the longitudinal axis of the screw plug.

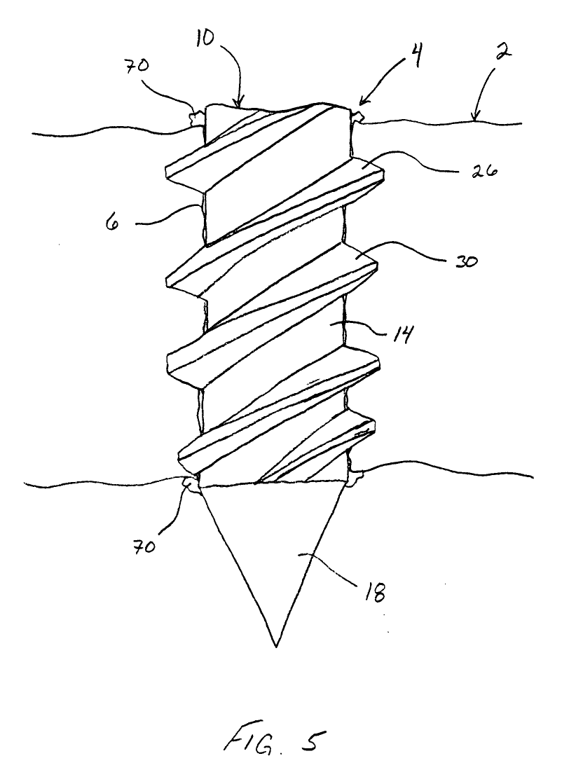

FIG. 5 illustrates a partial side view of the screw plug of FIGS. 1 and 2 as partially driven into a puncture 4 of a tire 2. As shown, by cutting into or impaling the wall of the tire 2, the screw shaft 14 is caused to come in contact with, and therefore press against the wall 6 to further facilitate an airtight seal. Indeed, as the screw plug 10 is driven into the tire 2, the first and second thread configurations 26 and 30 impale the wall 6 of the tire 2. As they do, a portion of the tire 2 is relaxed and caused to displace into the various roots defined by the thread configurations. As the screw plug is intended to comprise a larger minor diameter than the diameter of the puncture, as the portions of the tire 2 relax and enter the roots of the screw plug, they are caused to come into contact with the shaft 14, which creates additional pressure between the tire 2 and the screw plug 10.

The present invention further contemplates the use of a sealing agent to facilitate the seal of the screw plug once inserted or set, and to enable the screw plug to actually bond with the tire. Use of a sealing agent, however, is not required to achieve a proper airtight seal. Indeed, the screw plug of the present invention is designed to function to seal a puncture or leak within a pressurized vessel by itself without the use of a sealing agent. When a sealing agent is used, and once activated, a chemical reaction begins to take place between the freshly inserted screw and the material of the tire, which chemical reaction functions to vulcanize or fuse the screw plug with the tire, thus increasing the seal of the screw plug. The strength and timing of the bond will largely depend upon the sealing agent used and the makeup of the tire. Sealing agents are well known in the art and are not described in detail herein.

The sealing agent further functions as a lubricant that facilitates entry of the screw plug into the tire. This is particularly advantageous when the puncture is small, for example. As such, the sealing agent provides a two-fold function, namely to initially assist or facilitate the entry of the screw plug into the tire, and subsequently, to bond with the tire once the screw plug is set. FIG. 5 further illustrates the use of a sealing agent, shown as sealing agent 70, which is shown dispersed throughout the puncture 4.

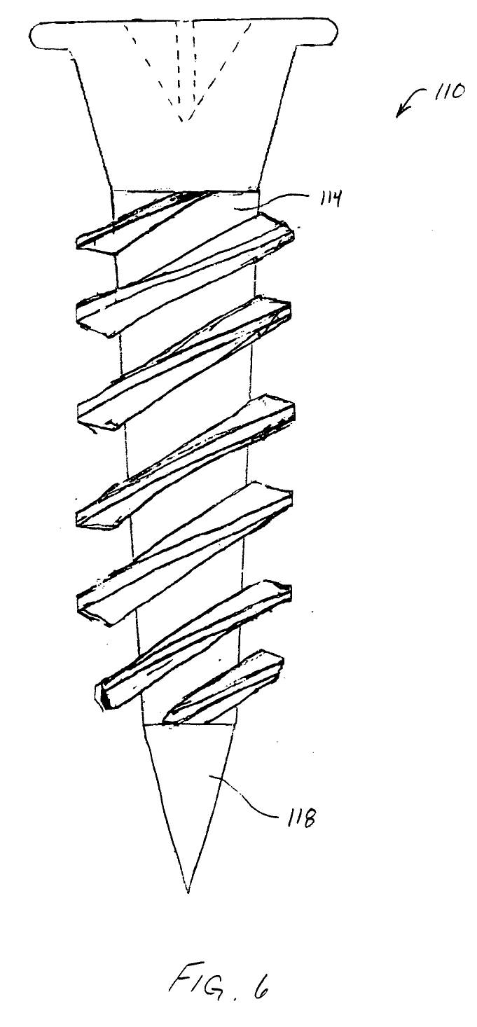

FIG. 6 illustrates a screw plug 110 in accordance with another exemplary embodiment of the present invention. The screw plug 110 is similar to the screw plug 10 described above, only the screw plug 110 comprises a tapering screw shaft 114 and a sharper screw tip 118. Much like the head portion 22 discussed above and shown in FIGS. 1, 2 and 4, having a tapering screw shaft 114 functions to provide different degrees of pressure to the tire as the screw plug is driven therein to seal a puncture. Once inserted, the thread configuration functions to resist the screw plug from being removed from the tire by the high air pressure wanting to push the screw plug outward from the puncture.

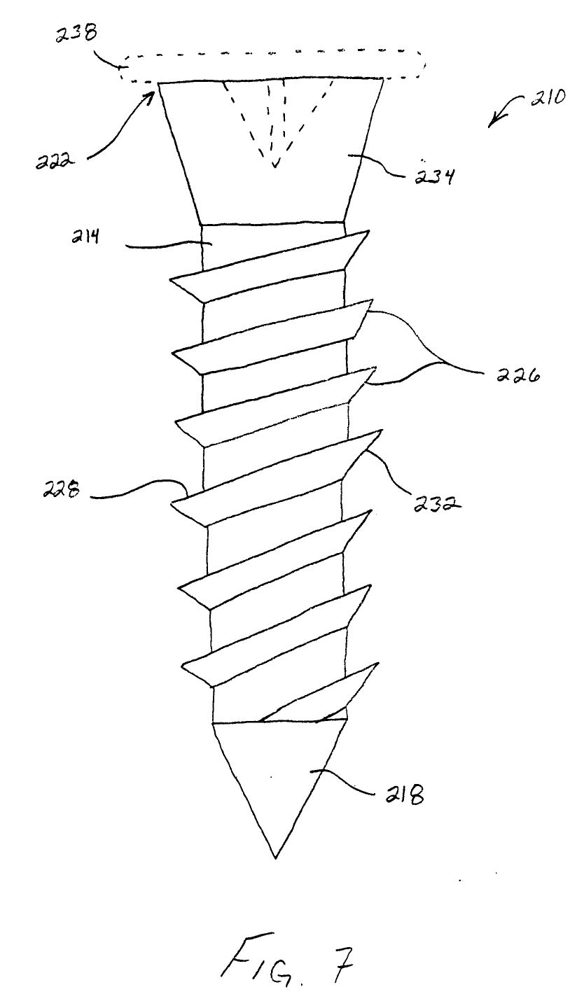

FIG. 7 illustrates a screw plug in accordance with still another exemplary embodiment of the present invention. As shown, the screw plug 210 comprises a screw shaft 214 having a first end and a second end, a truncated conical head portion 222 (similar in form and function to the one discussed above) having a tapered shaft 234, devoid of threads, and located about or extending from the first end of the screw shaft 214, and a thread configuration 226 disposed along the screw shaft 214.

The screw plug 210 may comprise a single or multiple thread configurations. The thread configuration 226 is shown as comprising a flat, upper surface 228 substantially orthogonal to a longitudinal axis of the screw plug 210, and a lower surface 232 extending from the upper surface 228 at an angle between 10 and 60 degrees, as measured from the upper surface 228. The thread configuration 226 is intended to cut into the wall of a tire, wherein the flat surface 228 is configured to provide greater resistance to any tendencies the screw plug 210 might have to back out of the tire. The flat surface 228 is intended to provide a surface that is more orthogonal to the screw shaft 214, as well as any forces acting along the longitudinal axis of the screw plug 210.

The screw shaft 214 may be cylindrical or tapered. In addition, the screw plug 210 may further comprise a rim 238 extending outward from the head portion 222, which rim 238 functions in a similar manner as discussed above.

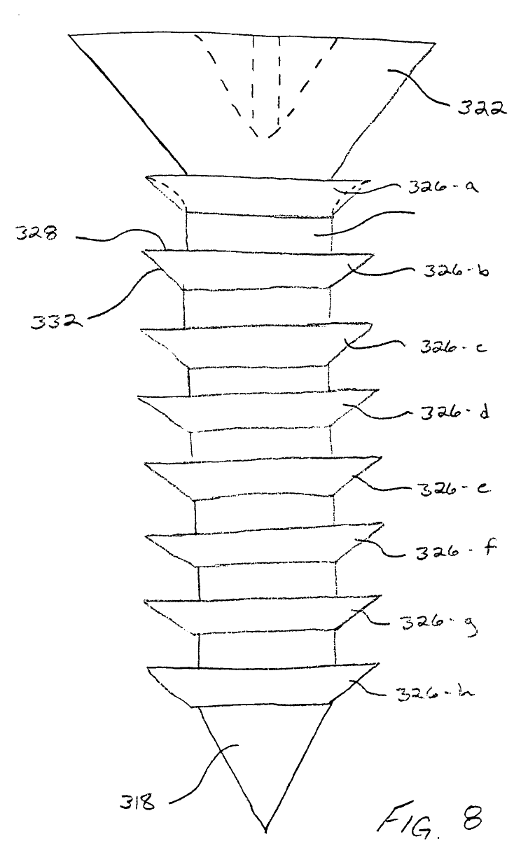

FIG. 8 illustrates another exemplary screw plug. As shown, the screw plug 310 comprises a screw shaft 314, a head portion 322, and a screw tip 318. In this particular embodiment, the screw plug comprises a series of individual retaining members, shown as retaining members 326-a-326-h, disposed about the screw shaft 314. The retaining members 326 each comprise a flat upper surface 328 and an inclined lower surface 332 similar to the thread design on the screw plug of FIG. 7. Each of the retaining members 326 are oriented so that they are substantially orthogonal to the longitudinal axis of the screw plug. With this particular design, the screw plug is not intended to be screwed into a pressure vessel, but instead pushed. Rotating the screw plug, however, may assist in inserting the screw plug into the pressure vessel.

The present invention further features a method for repairing a puncture in a tire. The method comprises various steps, namely locating a puncture in a pressure vessel, obtaining a screw plug for the purpose of sealing the puncture, aligning the screw plug, and particularly the screw tip, with the puncture, and rotating the screw plug to cause the multiple-thread configuration to impale a wall of the pressure vessel, and to set the screw plug to create an airtight seal. The screw plug may comprise any of the features set forth above. In one exemplary embodiment, the screw plug comprises a multiple-thread configuration configured to reduce the number of revolutions required to set the screw plug within the pressure vessel, a screw tip, and a head portion having a tapered shaft and a rim extending outward from the tapered shaft similar to the embodiment shown in FIG. 2. The method may further comprise using a sealing agent with the screw plug for the purposes discussed above. Once the screw plug is set, the pressure vessel may be re-inflated or re-pressurized with the screw plug sealing the puncture and preventing any air leaks.

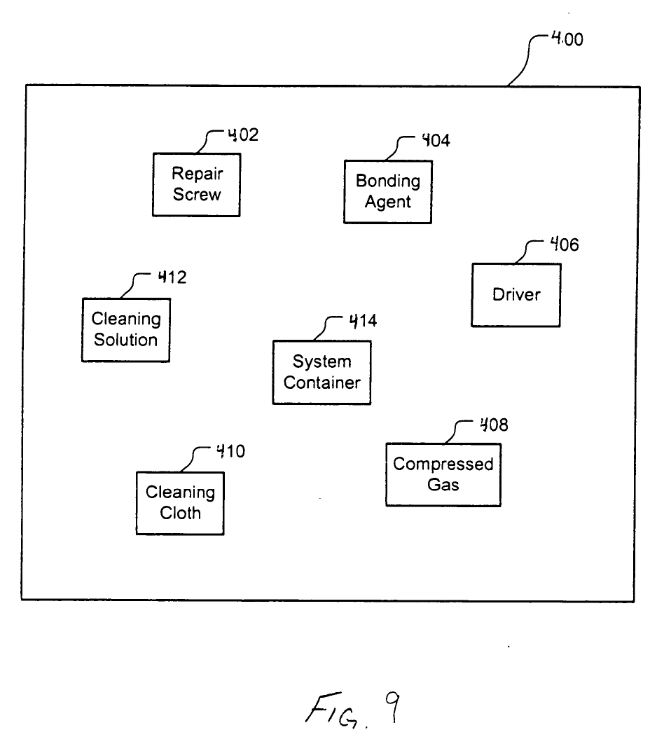

FIG. 9 shows an embodiment of a repair system according to one exemplary embodiment. The repair system 400 may include a screw plug 402 with multiple entry threads, as discussed above and shown in FIG. 1, and a sealing agent 404. The repair system may also comprise a driver 406 keyed to the screw plug, a compressed gas canister 408, and various cleaning items, such as a cleaning solution 412 or cleaning cloth 410. Providing these items together in a carrying container 414 can be convenient for any user in need of such a repair system.

The foregoing detailed description describes the invention with reference to specific exemplary embodiments. However, it will be appreciated that various modifications and changes can be made without departing from the scope of the present invention as set forth in the appended claims. The detailed description and accompanying drawings are to be regarded as merely illustrative, rather than as restrictive, and all such modifications or changes, if any, are intended to fall within the scope of the present invention as described and set forth herein.

More specifically, while illustrative exemplary embodiments of the invention have been described herein, the present invention is not limited to these embodiments, but includes any and all embodiments having modifications, omissions, combinations (e.g., of aspects across various embodiments), adaptations and/or alterations as would be appreciated by those in the art based on the foregoing detailed description. The limitations in the claims are to be interpreted broadly based on the language employed in the claims and not limited to examples described in the foregoing detailed description or during the prosecution of the application, which examples are to be construed as non-exclusive. For example, in the present disclosure, the term “preferably” is non-exclusive where it is intended to mean “preferably, but not limited to.” Any steps recited in any method or process claims may be executed in any order and are not limited to the order presented in the claims. Means-plus-function or step-plus-function limitations will only be employed where for a specific claim limitation all of the following conditions are present in that limitation: a) “means for” or “step for” is expressly recited; and b) a corresponding function is expressly recited. The structure, material or acts that support the means-plus function are expressly recited in the description herein. Accordingly, the scope of the invention should be determined solely by the appended claims and their legal equivalents, rather than by the descriptions and examples given above.

What is claimed and desired to be secured by Letters Patent is:

1. A screw plug for repair of a puncture in a pressure vessel, said screw plug comprising:
a screw shaft having a cylindrical configuration and a longitudinal central axis extending therethrough;
a first thread configuration disposed about said screw shaft; and
a second thread configuration disposed about said screw shaft and extending parallel to said first thread configuration, said first and second thread configurations initiating at different locations to provide a multiple-thread configuration.

2. The screw plug of claim 1, further comprising a tapered screw tip, devoid of threading, that extends from said screw shaft and is configured to facilitate insertion into said pressure vessel and to aid in alignment of said screw plug.

3. The screw plug of claim 1, further comprising a truncated conical head portion extending from said screw shaft and devoid of threads, said head portion having a driving slot formed therein configured to receive a driving tool for operably rotating and driving said screw plug into said puncture.

4. The screw plug of claim 3, wherein said head portion comprises a tapered shaft configured to facilitate an increased airtight seal, said tapered shaft functioning to expand a wall about said puncture as said screw plug is being seated, thus increasing the pressure between said pressure vessel and said screw plug.

5. The screw plug of claim 4, wherein said tapered shaft comprises a head angle between 1 and 30 degrees.

6. The screw plug of claim 3, further comprising a rim located atop and extending outward from said head portion, said rim being configured to seat against a surface of said pressure vessel to indicate a complete and proper insertion of said screw plug into said puncture, said rim also being configured to facilitate sealing of said screw plug, and to retain a sealing agent.

7. The screw plug of claim 3, wherein said head portion further comprises a driving slot configured to facilitate the driving of said screw plug into said pressure vessel.

8. The screw plug of claim 1, wherein said first thread configuration is configured to cut into a wall of said pressure vessel to cause said shaft portion to press against said wall.

9. The screw plug of claim 8, wherein said first thread configuration comprises a half thread angle between 20 and 35 degrees.

10. The screw plug of claim 1, wherein said second thread configuration is configured to cut into a wall of said pressure vessel to cause said shaft portion to press against said wall.

11. The screw plug of claim 10, wherein said second thread configuration comprises a half thread angle between 20 and 35 degrees.

12. The screw plug of claim 1, wherein at least one of said first and second thread configurations comprises a double deep cutting edge along a depth of said thread configuration, which functions to increase a pulling power of said screw plug and its ability to rapidly impale said pressure vessel.

13. The screw plug of claim 1, wherein said first and second thread configurations comprise a different height.

14. The screw plug of claim 1, wherein at least one of said first and second thread configurations comprise a flat, upper surface substantially orthogonal to a longitudinal axis of said screw plug, and a lower surface extending from said upper surface at an angle between 10 and 60 degrees, as measured from said upper surface.

15. A screw plug for repairing a puncture in a pressure vessel, said screw plug comprising:
a screw shaft;
a multiple-thread configuration formed about said screw shaft to reduce the number of revolutions required to insert and set said screw plug;
a head portion extending from said screw shaft, said head portion having a driving slot formed therein; and
a tapered screw tip, devoid of threading, configured to aid in alignment of said screw plug with respect to said puncture.

16. The screw plug of claim 15, wherein said screw shaft comprises a tapered configuration.

17. A method for repairing a pressure vessel, said method comprising:
locating a puncture in said pressure vessel;
obtaining a screw plug comprising:
a multiple-thread configuration configured to reduce the number of revolutions required to seat said screw plug within said pressure vessel;
a screw tip;
a head portion having a tapered shaft and a rim extending outward from said tapered shaft;
aligning said screw tip with said puncture; and
rotating said screw plug to cause said multiple-thread configuration to impale a wall of said pressure vessel, and to set said screw plug to create an airtight seal.

18. The method of claim 17, further comprising using a sealing agent with said screw plug, said sealing agent being configured to lubricate said screw plug during insertion into said puncture, and to bond said pressure vessel to increase said seal.

19. The method of claim 17, further comprising configuring at least one thread configuration of said multiple-thread configuration with a double deep cutting edge formed along a depth of said thread configuration, which functions to increase a pulling power of said screw plug and its ability to rapidly impale said pressure vessel.

20. A screw plug for repairing a pressure vessel, said screw plug comprising:
a screw shaft having a first end and a second end;
a truncated conical head portion, devoid of threads, and located about said first end of said screw shaft, said head portion further comprising a rim extending outward therefrom; and
a thread configuration disposed along said screw shaft, said thread configuration comprising a flat, upper surface substantially orthogonal to a longitudinal axis of said screw plug, and a lower surface extending from said upper surface at an angle between 10 and 60 degrees, as measured from said upper surface.
